(19) United States
(12) Patent Application Publication
(10) Pub. No.: US 2018/0327299 A1
(43) Pub. Date: Nov. 15, 2018

(54) APPARATUS AND METHOD FOR FORMING GLASS RIBBON

(71) Applicant: Corning Incorporated, Corning, NY (US)

(72) Inventors: Frank Coppola, Horseheads, NY (US); Vladislav Yuryevich Golyatin, Avon (FR); Timothy Douglas Lockwood, Rexville, NY (US); Monica Jo Mashewske, Lexington, NC (US)

(21) Appl. No.: 15/777,590

(22) PCT Filed: Nov. 16, 2016
(86) PCT No.: PCT/US2016/062187

§ 371 Date: May 18, 2018

Related U.S. Application Data
(60) Provisional application No. 62/258,176, filed on Nov. 20, 2015.

(51) Int. Cl. C03B 17/06

(52) U.S. Cl. CPC C03B 17/064

(57) ABSTRACT

An apparatus for forming a glass ribbon includes a forming body with opposing first and second forming surfaces. An end dam assembly includes a first forming dam wall extending in a draw direction along a first end of the first forming surface. A second forming dam wall can extend in the draw direction along a first end of the second forming surface. A first bridge dam wall can be disposed on an upper surface of the forming body and extend between and join the first forming dam wall and the second forming dam wall. Each of the forming body and the end dam assembly is formed from a refractory material. A method includes flowing a molten glass through a trench defined by forming dam walls extending in the draw direction along opposing first and second ends of the forming surface.

This application claims the benefit of priority to U.S. Provisional Application No. 62/258,176, filed Nov. 20, 2015, the content of which is incorporated herein by reference in its entirety.

### BACKGROUND

### 1. Field

This disclosure relates to apparatus and methods for forming glass ribbons.

### 2. Technical Background

A glass ribbon can be manufactured using a variety of different processes. One such process is a fusion draw process in which molten glass streams flow over opposing outer forming surfaces of a forming body that merge at a draw line. The molten glass streams flowing over the opposing outer forming surfaces merge at the draw line to form the glass ribbon.

### SUMMARY

Disclosed herein are apparatus and methods for forming glass ribbons.

Disclosed herein is an exemplary apparatus for forming a glass ribbon, the apparatus comprising a forming body comprising opposing first and second forming surfaces. The apparatus comprises an end dam assembly comprising a forming dam wall extending in a draw direction along a first end of the first forming surface. Each of the forming body and the end dam assembly comprises a refractory material.

Disclosed herein is an exemplary apparatus for forming a glass ribbon, the apparatus comprising a lower forming body comprising opposing first and second forming surfaces and an upper forming body disposed above the lower forming body and comprising opposing first and second forming surfaces. A lower bridge dam wall is disposed in a gap between the lower forming body and the upper forming body. Each of the lower forming body, the upper forming body, and the lower bridge dam wall comprises a refractory material.

Disclosed herein is an exemplary apparatus for forming a glass ribbon, the apparatus comprising a forming body comprising opposing first and second forming surfaces. The apparatus comprises an end dam assembly comprising a first forming dam wall extending in a draw direction along a first end of the first forming surface, a second forming dam wall extending in the draw direction along a first end of the second forming surface, a first bridge dam wall disposed on an upper surface of the forming body and extending between and joining the first forming dam wall and the second forming dam wall, a third forming dam wall extending in the draw direction along a second end of the first forming surface, a fourth forming dam wall extending in the draw direction along a second end of the second forming surface, and a second bridge dam wall disposed on the upper surface of the forming body and extending between and joining the third forming dam wall and the fourth forming dam wall. Each of the forming body and the end dam assembly comprises a refractory material.

Disclosed herein is an exemplary method for forming a glass ribbon, the method comprising flowing a molten glass in a draw direction along a forming surface of a forming body. The molten glass flows within a trench defined by forming dam walls extending in the draw direction along opposing first and second ends of the forming surface. Each of the forming body and the forming dam walls comprises a refractory material.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claimed subject matter. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of one embodiment of an apparatus for forming a glass ribbon.

FIG. 2 is a cross-sectional view of the forming body of the apparatus shown in FIG. 1.

FIG. 3 is an elevation view of the apparatus shown in FIG. 1.

FIG. 4 is a partially exploded view of the apparatus shown in FIG. 1.

FIG. 5 is a close-up perspective view of a compression end of a forming body of the apparatus shown in FIG. 1 without an end dam assembly installed.

FIG. 6 is a close-up perspective view of a compression end of a forming body of the apparatus shown in FIG. 1 with an end dam assembly installed.

FIG. 7 is a close-up perspective view of an inlet end of a forming body of the apparatus shown in FIG. 1 without an end dam assembly installed.

FIG. 8 is a close-up perspective view of an inlet end of a forming body of the apparatus shown in FIG. 1 with forming dam walls of an end dam assembly installed.

FIG. 9 is a close-up perspective view of an inlet end of a forming body of the apparatus shown in FIG. 1 with forming dam walls and a bridge dam wall of an end dam assembly installed.

FIG. 10 is a cross-sectional view of one embodiment of a forming dam wall configured to be coupled to a channel in a forming body with a dovetail joint.

FIG. 11 is a cross-sectional view of one embodiment of a forming dam wall configured to be coupled to a channel in a forming body with an L-slot joint.

FIG. 12 is a cross-sectional view of one embodiment of a forming dam wall configured to be coupled to a channel in a forming body with a T-slot joint.

FIG. 13 is a perspective view of one embodiment of an apparatus for forming a laminated glass ribbon.

FIG. 14 is a partially exploded view of the apparatus shown in FIG. 13.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

As used herein, the term “refractory material” refers to “nonmetallic materials having those chemical and physical properties that make them applicable for structures, or as components of systems, that are exposed to environments above 1000° F. (538° C.)” as defined in ASTM C71 “Standard Terminology Relating to Refractories.”

As used herein, the term “average coefficient of thermal expansion,” or “average CTE,” refers to the average coefficient of linear thermal expansion of a given material between 0° C. and 300° C. As used herein, the term “coefficient of thermal expansion,” or “CTE,” refers to the average coefficient of thermal expansion unless otherwise indicated. The CTE can be determined, for example, using the procedure described in ASTM E228 “Standard Test Method for Linear Thermal Expansion of Solid Materials With a Push-Rod Dilatometer.”

In various embodiments, an apparatus for forming a glass ribbon comprises a forming body and an end dam assembly. The forming body comprises opposing first and second forming surfaces. In some embodiments, the apparatus comprises a plurality of forming bodies, and the forming body can be an upper forming body or a lower forming body of the apparatus. The end dam assembly comprises a first forming dam wall extending in a draw direction along a first end of the first forming surface. Thus, the first forming surface is bounded on the first end by a forming dam wall of the end dam assembly. In some embodiments, the end dam assembly comprises a second forming dam wall extending in the draw direction along a first end of the second forming surface. Thus, the second forming surface is bounded on the first end by a forming dam wall of the end dam assembly. In some embodiments, the end dam assembly comprises a bridge dam wall disposed on an upper surface of the forming body and extending between and joining the first forming dam wall and the second forming dam wall. Each of the forming body and the end dam assembly comprises or is formed from a refractory material. Forming each of the forming body and the end dam assembly from a refractory material can reduce distortion of the end dam assembly during heat-up and/or operation of the apparatus compared to an apparatus comprising an end dam assembly formed from a non-refractory material as described herein.

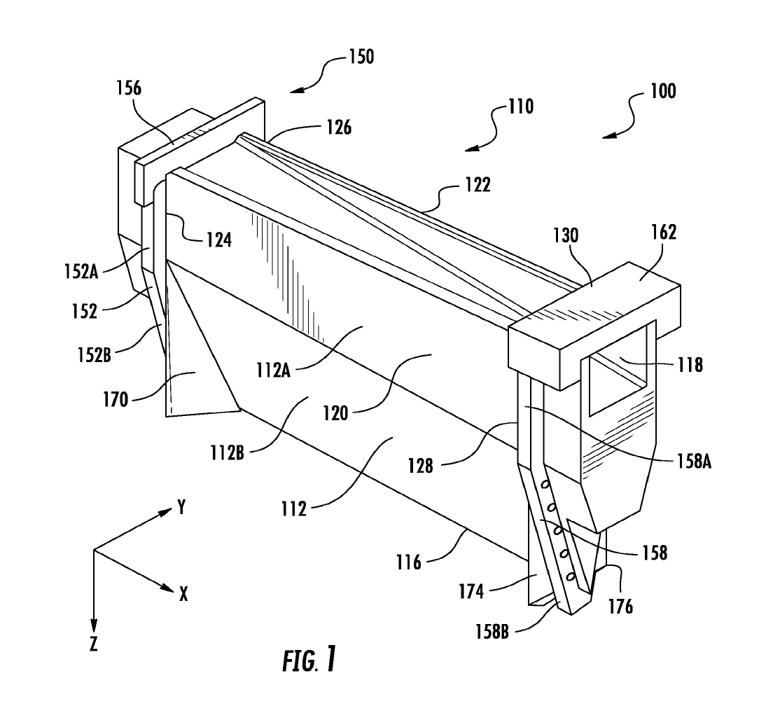

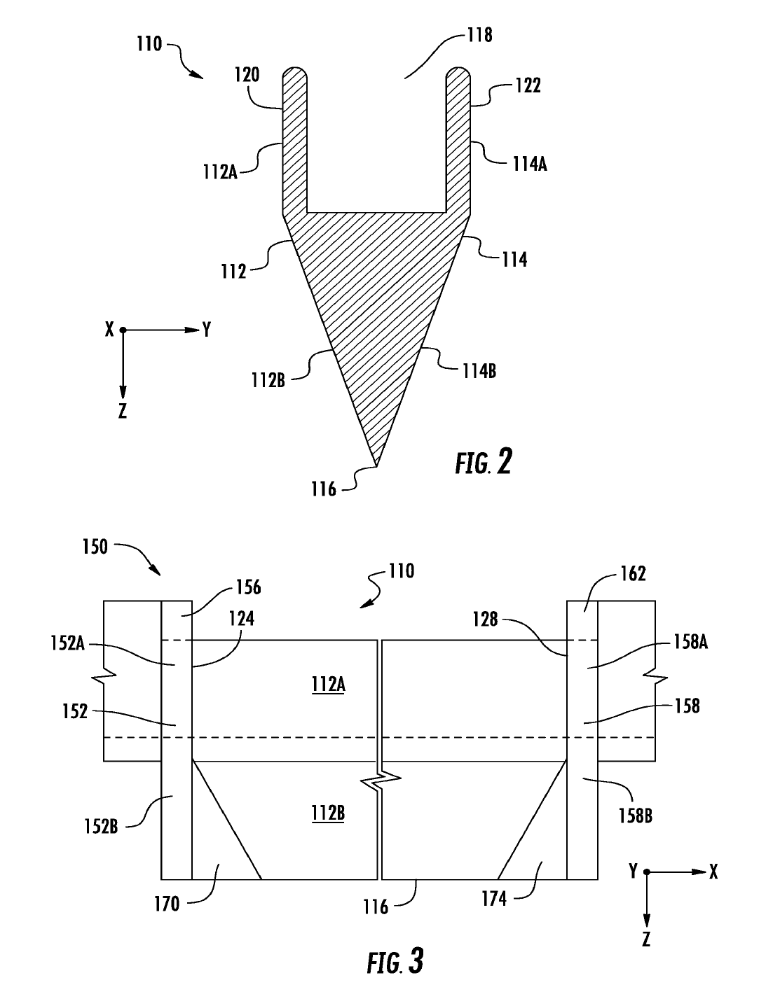

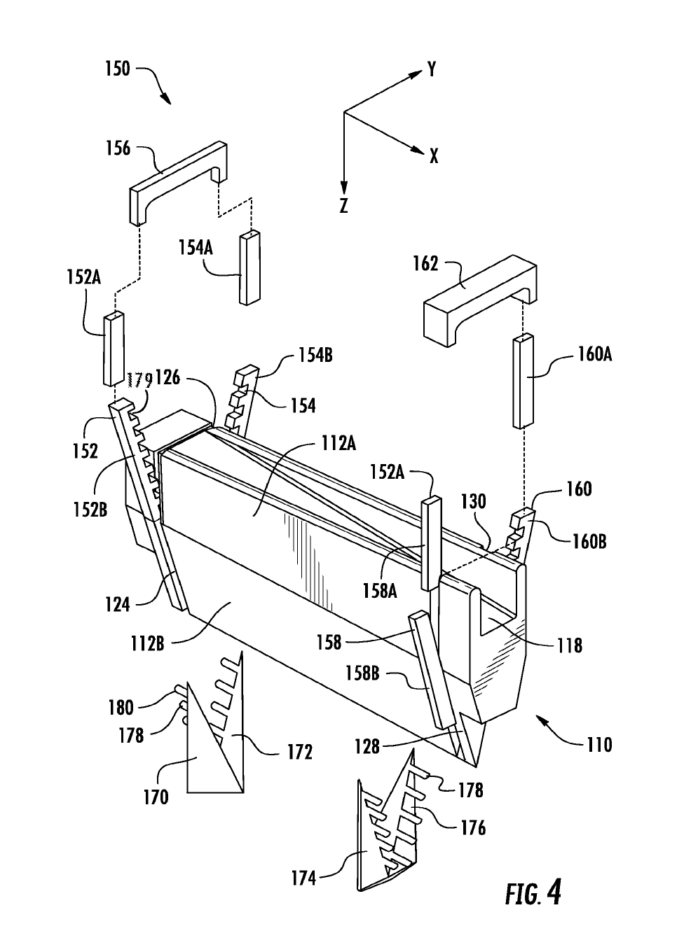

FIG. 1 is a perspective view of one embodiment of an apparatus 100 for forming a glass ribbon. Apparatus 100 comprises a wedge-shaped forming body 110 and an end dam assembly 150. FIG. 2 is a schematic cross-sectional view of forming body 110. FIG. 3 is an elevation view of apparatus 100. FIG. 4 is a partially exploded view of apparatus 100. As shown in FIGS. 1-4, forming body 110 comprises a first forming surface 112 and a second forming surface 114 opposite the first forming surface. First and second forming surfaces 112 and 114 converge at a draw line 116. In operation, streams of molten glass flow down opposing first and second forming surfaces 112 and 114. The streams of molten glass converge at or adjacent draw line 116 to form a glass ribbon. The glass ribbon is drawn continuously away from apparatus 100 in a draw direction (e.g., the Z direction).

In some embodiments, the apparatus is configured as an overflow distributor. For example, apparatus 100 comprises a trough 118 formed in an upper portion thereof. Trough 118 is bounded by a first sidewall 120 and a second sidewall 122 opposite the first sidewall. An outer surface of first sidewall 120 serves as at least a portion of first forming surface 112. An outer surface of second sidewall 122 serves as at least a portion of second forming surface 114. In operation, molten glass is fed into trough 118 from a melting and/or delivery system (not shown). The molten glass fills the trough and overflows each of first sidewall 120 and second sidewall 122 to form the streams of molten glass flowing down opposing first and second forming surfaces 112 and 114.

In some embodiments, first forming surface 112 comprises an upper portion 112A and a lower portion 112B. Additionally, or alternatively, second forming surface 114 comprises an upper portion 114A and a lower portion 1146. For example, in the embodiment shown in FIGS. 1-4, upper portion 112A of first forming surface 112 and upper portion 114A of second forming surface 114 comprise outer surfaces of first sidewall 120 and second sidewall 122, respectively, of trough 118, and lower portion 112B of the first forming surface and lower portion 114B of the second forming surface are disposed downstream of the first sidewall and the second sidewall, respectively, of the trough in the draw direction. In some embodiments, upper portion 112A of first forming surface 112 is substantially parallel or parallel to upper portion 114A of second forming surface 114. Lower portion 112B of first forming surface 112 and lower portion 1146 of second forming surface 114 are inclined relative to one another to define the wedge-shape of forming body 110.

Although forming body 110 shown in FIGS. 1-4 comprises first and second forming surfaces 112 and 114 of equal length (e.g., from an upper surface of the forming surface to draw line 116) such that the forming body is symmetrical about a central plane (e.g., the X-Z plane) of the forming body, other embodiments are included in this disclosure. For example, in some embodiments, the first forming surface is longer than the second forming surface such that the forming body is asymmetrical about the central plane. In such embodiments, the draw line is offset in a thickness direction (e.g., the Y direction) from the central plane of the forming body.

Although forming body 110 shown in FIGS. 1-4 is configured as an overflow distributor in which molten glass overflows trough 118 and flows over opposing first and second sidewalls 120 and 122 of the trough (e.g., a double-sided overflow distributor), other embodiments are included in this disclosure. For example, in some embodiments, the forming body is configured as an overflow distributor in which molten glass overflows the trough and flows over only one sidewall of the trough (e.g., a single-sided overflow distributor). In other embodiments, the trough is omitted such that molten glass is deposited on the upper surface of the overflow distributor and allowed to flow down the forming surfaces.

End dam assembly 150 comprises a first forming dam wall 152 extending in the draw direction along a first end 124 of first forming surface 112. Thus, first forming surface 112 is bounded at first end 124 by first forming dam wall 152. Additionally, or alternatively, end dam assembly 150 comprises a second forming dam wall 154 extending in the draw direction along a first end 126 of second forming surface 114. Thus, second forming surface 114 is bounded at first end 126 by second forming dam wall 154. Additionally, or alternatively, end dam assembly 150 comprises a first bridge dam wall 156 disposed on an upper surface of forming body 110 and extending in a thickness direction (e.g., the Y-direction). First bridge dam wall 156 extends between and joins first forming dam wall 152 and second forming dam wall 154. In some embodiments, first forming dam wall 152 and second forming dam wall 154 converge at or near draw line 116 of forming body 110. For example, first forming dam wall 152 and second forming dam wall 154 are joined to one another just beneath draw line 116 to guide the glass ribbon flowing off of forming body 110.

In some embodiments, end dam assembly 150 comprises a third forming dam wall 158 extending in the draw direction along a second end 128 of first forming surface 112 opposite first end 124. Thus, first forming surface 112 is bounded at second end 128 by third forming dam wall 158. Additionally, or alternatively, end dam assembly 150 comprises a fourth forming dam wall 160 extending in the draw direction along a second end 130 of second forming surface 114 opposite first end 126. Thus, second forming surface 114 is bounded at second end 130 by fourth forming dam wall 160. Additionally, or alternatively, end dam assembly 150 comprises a second bridge dam wall 162 disposed on the upper surface of forming body 110 and extending in the thickness direction. Second bridge dam wall 162 extends between and joins third forming dam wall 158 and fourth forming dam wall 160. In some embodiments, third forming dam wall 158 and fourth forming dam wall 160 converge at or near draw line 116 of forming body 110. For example, third forming dam wall 158 and fourth forming dam wall 160 are joined to one another just beneath draw line 116 to guide the glass ribbon flowing off of forming body 110.

In the embodiment shown in FIGS. 1-4, end dam assembly 150 comprises first forming dam wall 152, second forming dam wall 154, and first bridge dam wall 156 disposed near a compression end of forming body 110 and third forming dam wall 158, fourth forming dam wall 160, and second bridge dam wall 162 disposed near an inlet end of the forming body opposite the compression end. First forming surface 112 is bounded at first end 124 by first forming dam wall 152 and at second end 128 by third forming dam wall 158. Thus, first forming surface 112 extends laterally (e.g., in the X direction) between first forming dam wall 152 and third forming dam wall 158. Second forming surface 114 is bounded at first end 126 by second forming dam wall 154 and at second end 130 by fourth forming dam wall 160. Thus, second forming surface 114 extends laterally (e.g., in the X direction) between second forming dam wall 154 and fourth forming dam wall 160.

The end dam assembly can help to guide the flow of molten glass onto and/or down the forming surfaces and/or to prevent the molten glass from flowing off the ends and/or sides of the forming surfaces. For example, first forming dam wall 152 and third forming dam wall 158 extend outward (e.g., away from forming body 110) beyond first forming surface 112. Thus, first forming dam wall 152, third forming dam wall 158, and first forming surface 112 collectively form a trench through which molten glass flows during operation of apparatus 100. Additionally, or alternatively, second forming dam wall 154 and fourth forming dam wall 160 extend outward beyond second forming surface 114. Thus, second forming dam wall 154, fourth forming dam wall 160, and second forming surface 114 collectively form a trench through which molten glass flows during operation of apparatus 100. In some embodiments, first bridge dam wall 156 and/or second bridge dam wall 162 extend outward beyond the upper surface of forming body 110. Such extension of the bridge dam walls can help to prevent molten glass from flowing around the forming dam walls and/or over the ends of the forming body to direct the molten glass onto the forming surfaces.

Each of forming body 110 and end dam assembly 150 comprises or is formed from a refractory material. For example, the refractory material is selected from the group consisting of zirconia, silicon carbide, alumina, and combinations thereof. In some embodiments, forming body 110 and end dam assembly 150 comprise or are formed from the same refractory material. In other embodiments, forming body 110 and end dam assembly 150 comprise or are formed from different refractory materials. In some embodiments, different portions of end dam assembly 150 comprise or are formed from different materials. For example, the forming dam walls of end dam assembly 150 comprise or are formed from a non-refractory material, and bridge dam walls of end dam assembly 150 comprise or are formed from the refractory material. Also for example, the forming dam walls of end dam assembly 150 comprise or are formed from the refractory material, and bridge dam walls of end dam assembly 150 comprise or are formed from the non-refractory material.

In operation, the forming body and the end dam assembly, or portions thereof, are in contact with molten glass. Thus, in operation, the forming body and the end dam assembly can be subjected to temperatures in excess of 1000° C. The apparatus with the forming body and the end dam assembly comprising a refractory material as described herein can exhibit reduced shape distortion during heat-up and/or operation compared to an apparatus with an end dam assembly formed from a non-refractory material (e.g., a metallic material such as platinum, rhodium, titanium, alloys thereof, or combinations thereof). For example, when an apparatus with the forming body comprising a refractory material and the end dam assembly comprising a non-refractory material is heated, the end dam assembly can expand more than the forming body (e.g., as a result of the higher CTE of the non-refractory material compared to the lower CTE of the refractory material). Such increased expansion of the end dam assembly can cause warpage of the forming dam walls, which can lead to perturbations of the flow profile of the molten glass flowing down the forming surfaces and imperfections in the glass ribbon. Additionally, or alternatively, such warpage can lead to a gap between the forming dam walls and the forming surfaces, which can enable molten glass to leak through the gap and away from the forming surfaces. In contrast, when apparatus 100 comprising forming body 110 and end dam assembly 150 each formed from a refractory material is heated, the expansion of the end dam assembly can be comparable to the expansion of the forming body so that warpage of the forming dam walls is avoided. Thus, forming the forming body and the end dam assembly from a refractory material can help to maintain tighter tolerances between the forming body and the end dam assembly, which can enable a more accurate glass flow profile and/or reduce the potential for glass leakage.

In some embodiments, end dam assembly 150, or a portion thereof, is separate from and in contact with or coupled to forming body 110. Such a modular configuration of the forming body and the end dam assembly can simplify the manufacturing process of apparatus 100, but can result in weak points at interfaces between independent components. In other embodiments, end dam assembly 150, or a portion thereof, is integral with forming body 110. For example, forming body 110 and end dam assembly 150, or a portion thereof, comprise a unitary body formed (e.g., machined, cast, forged, or 3D printed) from the refractory material. Such an integral configuration of the forming body and the end dam assembly can be relatively strong, but can be difficult to manufacture.

In the embodiment shown in FIG. 4, end dam assembly 150 is separate from forming body 110 and comprises a plurality of end dam segments. The end dam segments are separate from one another. The segmented end dam configuration can enable assembly of the apparatus by coupling each end dam segment to the proper location on the forming body and/or to one or more adjacent end dam segments. For example, first forming dam wall 152 comprises an upper segment 152A and a lower segment 152B that are separate from one another. When assembled, upper segment 152A is adjacent upper portion 112A of first forming surface 112, lower segment 152B is adjacent lower portion 112B of the first forming surface, and the upper and lower segments are engaged with one another to cooperatively define first forming dam wall 152. The segmented end dam configuration enables inserting rigid upper and lower segments 152A and 1526 along upper and lower portions 112A and 1126 of first forming surface 112 even though the forming surface portions are disposed at an angle relative to one another. For example, the rigid dam wall segments can be inserted into respective portions of a channel formed in forming body 110 as described herein such that the dam wall segments are disposed at an angle relative to one another. Additionally, or alternatively, second forming dam wall 154 comprises an upper segment 154A and a lower segment 154B that are separate from one another. When assembled, upper segment 154A is adjacent upper portion 114A of second forming surface 114, lower segment 154B is adjacent lower portion 114B of the second forming surface, and the upper and lower segments are engaged with one another to cooperatively define second forming dam wall 154. Additionally, or alternatively, first bridge dam wall 156 is separate from first forming dam wall 152 and second forming dam wall 154. When assembled first bridge dam wall 156 extends between and is engaged with each of first forming dam wall 152 and second forming dam wall 154.

In the embodiment shown in FIG. 4, third forming dam wall 158 comprises an upper segment 158A and a lower segment 1586 that are separate from one another. When assembled, upper segment 158A is adjacent upper portion 112A of first forming surface 112, lower segment 1586 is adjacent lower portion 112B of the first forming surface, and the upper and lower segments are engaged with one another to cooperatively define third forming dam wall 158. Additionally, or alternatively, fourth forming dam wall 160 comprises an upper segment 160A and a lower segment 160B that are separate from one another. When assembled, upper segment 160A is adjacent upper portion 114A of second forming surface 114, lower segment 160B is adjacent lower portion 114B of the second forming surface, and the upper and lower segments are engaged with one another to cooperatively define fourth forming dam wall 160. Additionally, or alternatively, second bridge dam wall 162 is separate from third forming dam wall 158 and fourth forming dam wall 160. When assembled second bridge dam wall 162 extends between and is engaged with each of third forming dam wall 158 and fourth forming dam wall 160.

In various embodiments, the end dam assembly can comprise a determined number of segments. Additionally, or alternatively, different segments of the end dam assembly can be separate from or integral with one another. For example, in some embodiments, a bridge dam wall is integral with the upper portion of one or both adjacent forming dam walls. In various embodiments, portions of the end dam assembly can be integral with the forming body while other portions of the end dam assembly are separate from the forming body.

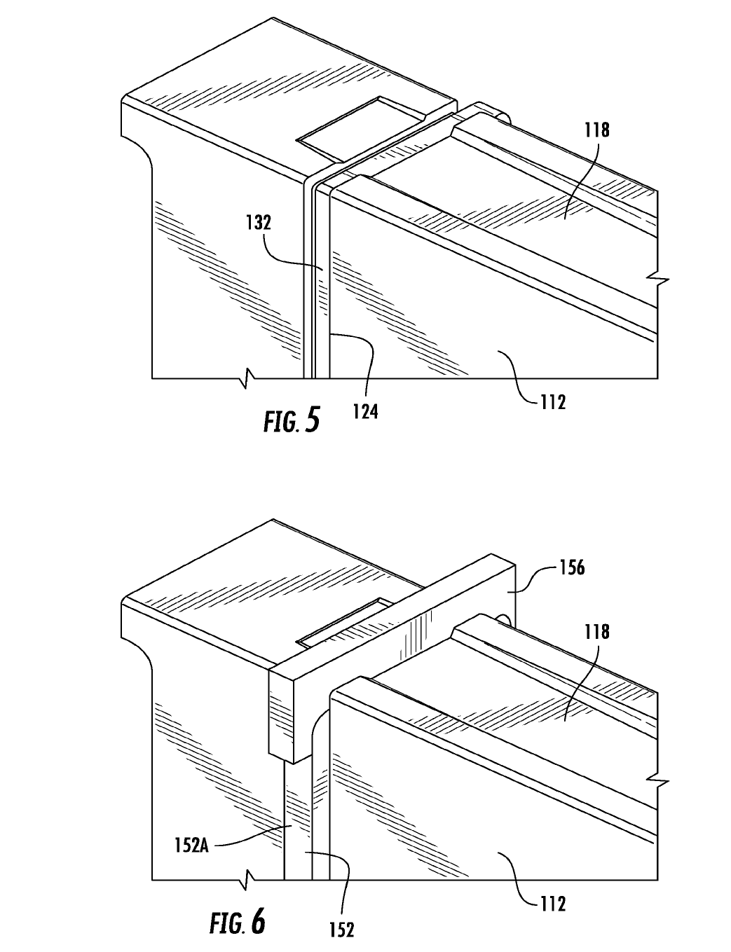

In embodiments in which the end dam assembly, or a portion thereof, is separate from the forming body, the end dam assembly, or portion thereof, can be coupled to the forming body. FIG. 5 is a close-up perspective view of the compression end of forming body 110 without an end dam assembly installed, and FIG. 6 is a close-up perspective view of the compression end of the forming body with end dam assembly 150 installed. As shown in FIG. 5, forming body 110 comprises a channel 132 formed therein. Channel 132 extends in the draw direction along first end 124 of first forming surface 112. Additionally, or alternatively, channel 132 extends in the draw direction along first end 126 of second forming surface 114. Additionally, or alternatively, channel 132 extends in the thickness direction along the upper surface of forming body 110. In some embodiments, the end dam assembly, or a portion thereof, is received within a channel in the forming body. For example, in the embodiment shown in FIG. 6, first forming dam wall 152, second forming dam wall 154, and first bridge dam wall 156 are received within channel 132.

Adjacent portions of the end dam assembly can be coupled to one another such that the adjacent components are joined to form the dam wall. For example, in the embodiment shown in FIG. 6, upper portion 152A of first forming dam wall 152 is disposed adjacent first bridge dam wall 156. First bridge dam wall 156 abuts and overlaps upper portion 152A of first forming dam wall 152A to form a substantially continuous forming wall. Upper and lower portions 152A and 152B can abut one another in a similar manner to form the substantially continuous forming wall. In some embodiments, adjacent portions of the end dam assembly are joined to one another with a fitting such as a pin and slot fitting as described herein.

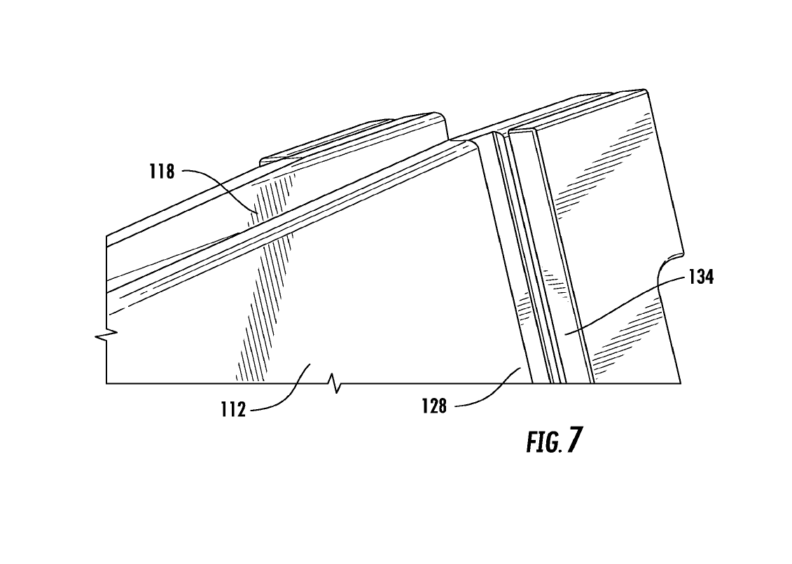

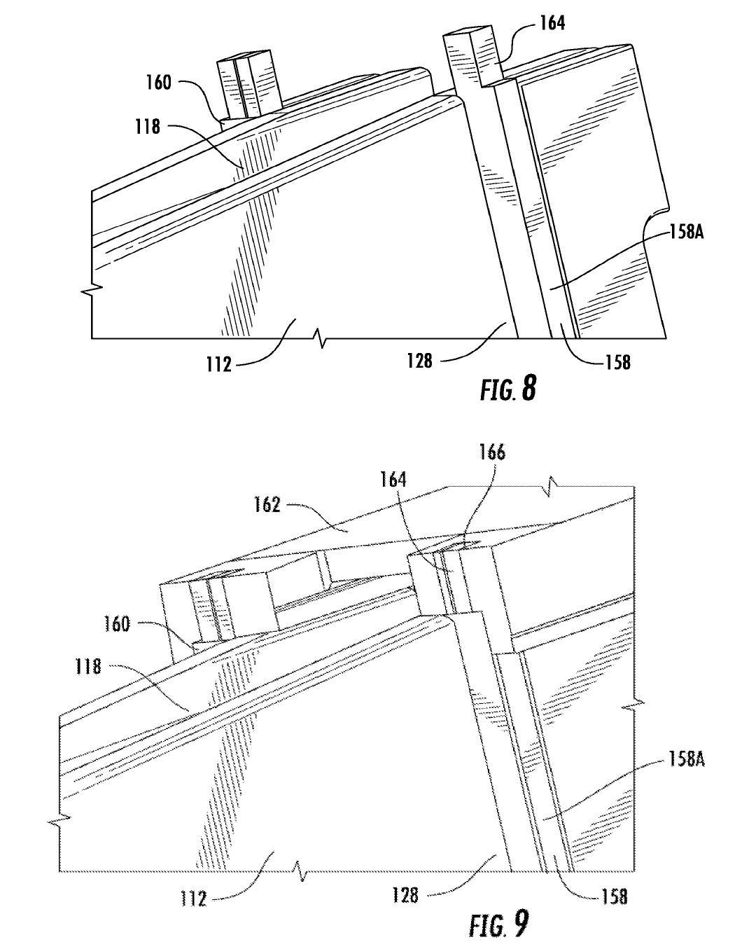

FIG. 7 is a close-up perspective view of the inlet end of forming body 110 without an end dam assembly installed. FIG. 8 is a close-up perspective view of the inlet end of forming body 110 with third forming dam wall 158 and fourth forming dam wall 160, but without a bridge dam wall of end dam assembly 150 installed. FIG. 9 is a close-up perspective view of the inlet end of forming body 110 with each of third forming dam wall 158, fourth forming dam wall 160, and second bridge dam wall 162 of end dam assembly 150 installed. As shown in FIG. 7, forming body 110 comprises a channel 134 formed therein. Channel 134 extends in the draw direction along second end 128 of first forming surface 112. Additionally, or alternatively, channel 134 extends in the draw direction along second end 130 of second forming surface 114. In the embodiment shown in FIG. 7, channel 134 does not extend in the thickness direction along the upper surface of forming body 110. In some embodiments, the end dam assembly, or a portion thereof, is received within a channel in the forming body. For example, in the embodiment shown in FIGS. 8-9, third forming dam wall 158 and fourth forming dam wall 160 are received within channel 134. As shown in FIG. 9, second bridge dam wall 162 is disposed on the upper surface of forming body 110 and not received within channel 134. Thus, second bridge dam wall 162 is disposed on the upper surface of forming body 110 such that an inlet to trough 118 is open beneath the second bridge dam wall.

Adjacent portions of the end dam assembly can be coupled to one another with a fitting such that the adjacent components are joined to form the dam wall. For example, in the embodiment shown in FIGS. 8-9, upper portion 158A of third forming dam wall 158 is disposed adjacent second bridge dam wall 160. Upper portion 158A of third forming dam wall 158 comprises a pin 164 protruding from an upper surface thereof. Second bridge dam wall 162 comprises a slot 166 formed therein and configured to engage pin 164. Thus, upper portion 158A of third forming dam wall 158 and second bridge dam wall 162 can be joined to one another with a pin and slot fitting. For example, pin 164 and slot 166 comprise complementary cross-sectional shapes such that the pin is engageable with the slot. In the embodiment shown in FIGS. 8-9, each of pin 164 and slot 166 comprises a square cross-sectional shape such that the pin can be inserted into the slot to couple upper portion 158A of third forming dam wall 158 and second bridge dam wall 162. In other embodiments, the pin and the slot comprise a round, triangular, rectangular, pentagonal, hexagonal, or another polygonal or non-polygonal shape. Upper and lower portions 158A and 158B of third forming dam wall 158 can be coupled to one another in a similar manner to form the substantially continuous forming wall.

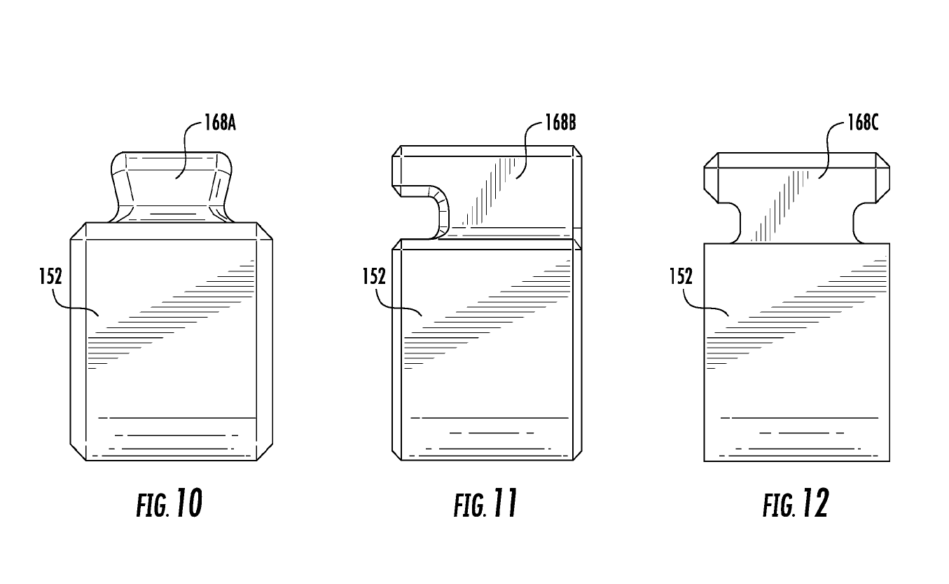

In some embodiments, the end dam assembly or a portion thereof, is coupled to the channel in the forming body with a joint. For example, the joint can be selected from the group consisting of a dovetail joint, an L-slot joint, a T-slot joint, or a combination thereof. FIGS. 10-12 are cross-sectional views of exemplary configurations of first forming dam wall 152 with three different joint configurations that can be used to couple end dam assembly 150, or a portion thereof, to channel 132 in forming body 110. In the embodiment shown in FIG. 10, the joint comprises a dovetail joint. First forming dam wall 152 comprises a tapered protrusion 168A extending therefrom. Protrusion 168A tapers from a relatively narrow waste at a proximal end thereof and to a relatively wide base at a distal end thereof. In the embodiment shown in FIG. 11, the joint comprises an L-slot joint. First forming dam wall 152 comprises an L-shaped protrusion 168B extending therefrom. In the embodiment shown in FIG. 12, the joint comprises a T-slot joint. First forming dam wall 152 comprises a T-shaped protrusion 168C extending therefrom. In various embodiments, channel 132 comprises a cross-sectional shape that is complementary to a cross-sectional shape of the protrusion such that the protrusion is engageable with the channel (e.g., by sliding the protrusion into the channel from an end of the channel). Thus, the forming dam wall can be coupled to the channel in the forming body with the joint.

The joint configuration is not limited to those shown in FIGS. 10-12. In other embodiments, the protrusion and the channel can have any suitable cross-sectional shape capable of facilitating engagement between the forming dam wall and the forming body. In some embodiments, the forming body comprises the protrusion (e.g., in place of the channel described with reference to FIGS. 5-9), and the end dam assembly, or portion thereof, comprises a corresponding channel.

In some embodiments, the apparatus comprises one or more edge extensions extending between a forming surface of the forming body and a forming dam wall. The edge extensions can help to guide the molten glass flowing over and/or off of the forming surfaces of the forming body to enable formation of a uniform glass ribbon. The edge extensions can be configured, for example, as described in U.S. Pat. No. 7,685,841, which is incorporated herein by reference in its entirety. For example, in the embodiment shown in FIGS. 1-4, apparatus 100 comprises a first edge extension 170 extending between first forming surface 112 of forming body 110 and first forming dam wall 152 of end dam assembly 150. First edge extension 170 is positioned adjacent lower portion 112B of first forming surface 112. First edge extension 170 comprises a guiding surface that extends between first forming surface 112 and first forming dam wall 152. In some embodiments, first edge extension 170 comprises an inner surface that is engageable with first forming surface 112, a rear surface that is engageable with first forming dam wall 152, and/or a lower surface that spans between the guiding surface, the inner surface, and/or the rear surface. In some embodiments, first edge extension 170 comprises an oblique pyramidal shape with a triangular base. In the embodiment shown in FIGS. 1-4, apparatus 100 comprises a second edge extension 172 extending between second forming surface 114 of forming body 110 and second forming dam wall 154 of end dam assembly 150. Second edge extension 172 is positioned adjacent lower portion 114B of second forming surface 114. Second edge extension 172 comprises a guiding surface that extends between second forming surface 114 and second forming dam wall 154. In some embodiments, second edge extension 172 comprises an inner surface that is engageable with second forming surface 114, a rear surface that is engageable with second forming dam wall 154, and/or a lower surface that spans between the guiding surface, the inner surface, and/or the rear surface. In some embodiments, second edge extension 172 comprises an oblique pyramidal shape with a triangular base.

First edge extension 170 and second edge extension 172 can converge proximate draw line 116 of forming body 110. In some embodiments, first edge extension 170 and second edge extension 172 are part of a unitary edge extension assembly. In other embodiments, first edge extension 172 and second edge extension 172 are separate components.

In the embodiment shown in FIGS. 1-4, apparatus 100 comprises a third edge extension 174 extending between first forming surface 112 of forming body 110 and third forming dam wall 158 of end dam assembly 150. Third edge extension 174 is positioned adjacent lower portion 112B of first forming surface 112. Third edge extension 174 comprises a guiding surface that extends between first forming surface 112 and third forming dam wall 158. In some embodiments, third edge extension 174 comprises an inner surface that is engageable with first forming surface 112, a rear surface that is engageable with third forming dam wall 158, and/or a lower surface that spans between the guiding surface, the inner surface, and/or the rear surface. In some embodiments, third edge extension 174 comprises an oblique pyramidal shape with a triangular base. In the embodiment shown in FIGS. 1-4, apparatus 100 comprises a fourth edge extension 176 extending between second forming surface 114 of forming body 110 and fourth forming dam wall 160 of end dam assembly 150. Fourth edge extension 176 is positioned adjacent lower portion 114B of second forming surface 114. Fourth edge extension 176 comprises a guiding surface that extends between second forming surface 114 and fourth forming dam wall 160. In some embodiments, fourth edge extension 176 comprises an inner surface that is engageable with second forming surface 114, a rear surface that is engageable with fourth forming dam wall 160, and/or a lower surface that spans between the guiding surface, the inner surface, and/or the rear surface. In some embodiments, fourth edge extension 176 comprises an oblique pyramidal shape with a triangular base.

Third edge extension 174 and fourth edge extension 176 can converge proximate draw line 116 of forming body 110. In some embodiments, third edge extension 174 and fourth edge extension 176 are part of a unitary edge extension assembly. In other embodiments, third edge extension 174 and fourth edge extension 176 are separate components.

In some embodiments, the edge extensions can be removably attached to the end dam assembly. For example, in the embodiment shown in FIG. 4, the edge extensions comprise one or more tabs 178 protruding therefrom (e.g., from rear surfaces). Tabs 178 can be engaged with (e.g., wrapped around) the forming dam walls of end dam assembly 150 to attach the edge extensions thereto. For example, tabs 178 can be disposed within grooves formed on an inner surface of the forming dam walls (e.g., grooves 179 formed on an inner surface of lower segment 152B of first forming dam wall 152 as shown in FIG. 4). Thus, tabs 178 can be wrapped around the forming dam walls and/or pinched between the forming dam walls and the forming body without interfering with the engagement of the forming dam walls with the forming body as described herein. Additionally, or alternatively, the edge extensions comprise one or more hooks 180 protruding therefrom. Hooks 180 can be engaged with the forming dam walls of end dam assembly 150 to attach the edge extensions thereto. In some embodiments, the edge extensions comprise or are formed from a non-refractory material. For example, the edge extensions are formed from a metal. The removable attachment can enable efficient replacement of worn edge extensions.

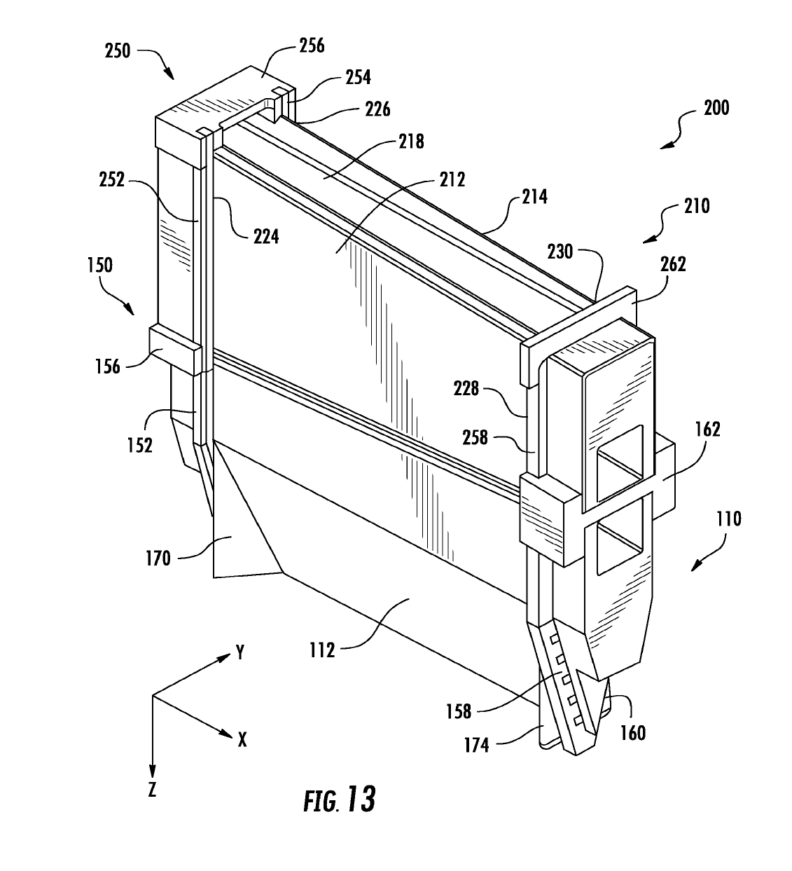

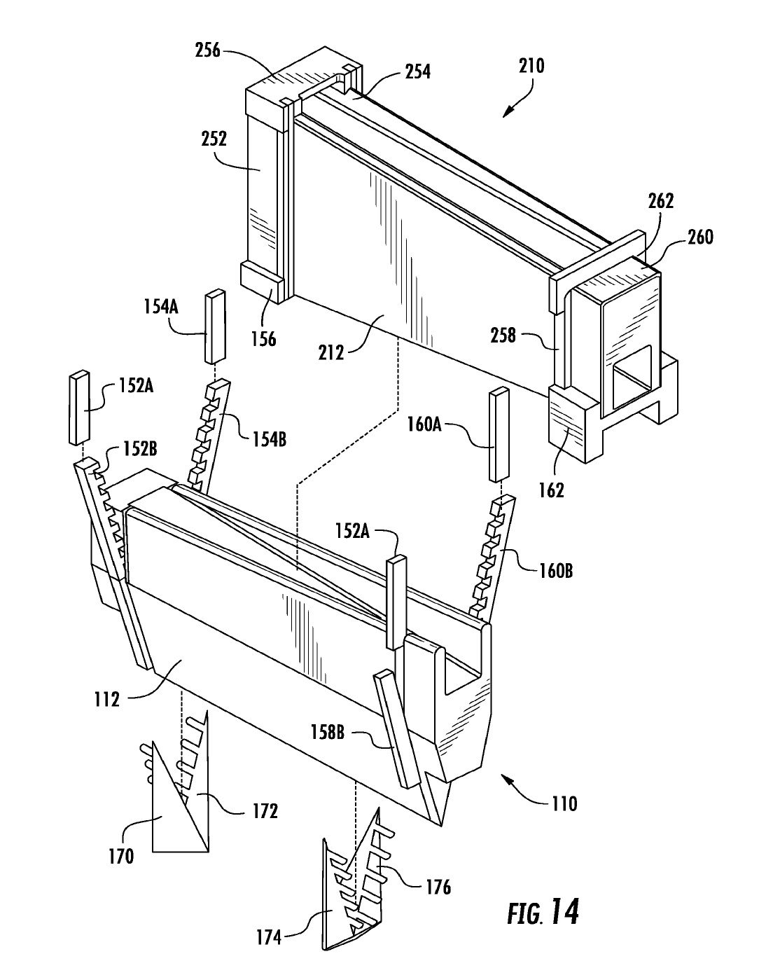

FIG. 13 is a perspective view of another embodiment of an apparatus 200 for forming a glass ribbon. FIG. 14 is a partially exploded view of apparatus 200. Apparatus 200 is configured to form a laminate glass ribbon. Accordingly, apparatus 200 comprises multiple forming bodies, for example, as described in U.S. Pat. No. 4,214,886, which is incorporated herein by reference in its entirety. In the embodiment shown in FIGS. 13-14, apparatus 200 comprises forming body 110 and a second forming body 210. Second forming body 210 is disposed above forming body 110. Thus, forming body 210 comprises an upper forming body, and forming body 110 comprises a lower forming body. Second forming body 210 can be configured as described herein with respect to forming body 110, except for the differences described herein. For example, second forming body 210 comprises a first forming surface 212 and a second forming surface 214 opposite the first forming surface. Unlike forming body 110, first and second forming surfaces 212 and 214 of second forming body 210 do not converge, but remain separate at a downstream end of the second forming body. In operation, streams of molten glass flow down opposing first and second forming surfaces 212 and 214. The streams of molten glass from second forming body 210 merge with or fuse to the streams of molten glass flowing over first and second forming surfaces 112 and 114 of forming body 110. The merged streams of molten glass flowing down first and second forming surfaces 112 and 114 converge at or adjacent draw line 116 to form the laminated glass ribbon. The glass ribbon is drawn continuously away from apparatus 200 in a draw direction (e.g., the Z direction).

In some embodiments, apparatus 200 is configured as an overflow distributor. For example, apparatus 200 comprises a trough 218 formed in an upper portion thereof. In operation, molten glass is fed into trough 218 from a melting and/or delivery system (not shown). The molten glass fills trough 218 and overflows opposing sidewalls of the trough to form the streams of molten glass flowing down opposing first and second forming surfaces 212 and 214. In some embodiments, first forming surface 212 is substantially parallel or parallel to second forming surface 214.

In some embodiments, the molten glass that flows down opposing first and second forming surfaces 212 and 214 of second forming body 210 comprises a different glass composition than the molten glass that flows down opposing first and second forming surfaces 112 and 114 of forming body 110. Thus, the laminated glass ribbon comprises a plurality of layers with different glass compositions. The properties of the laminated glass ribbon can be determined at least in part by the properties of the glass compositions. For example the glass composition that flows down second forming body 210 can comprise a lower CTE than the glass composition that flows down forming body 110 such that the laminated glass ribbon comprises a relatively high CTE core layer disposed between relatively low CTE cladding layers. Upon cooling, the cladding layers of such a laminated glass ribbon can be in compression, while the core layer can be in tension.

Apparatus 200 comprises a second end dam assembly 250. Thus, end dam assembly 150 comprises a lower end dam assembly, and second end dam assembly 250 comprises an upper end dam assembly. Second end dam assembly 250 can be configured generally as described herein with reference to end dam assembly 150, except for the differences described herein. For example, second end dam assembly 250 comprises a first forming dam wall 252 extending in the draw direction along a first end 224 of first forming surface 212 and/or a second forming dam wall 254 extending in the draw direction along a first end 226 of second forming surface 214. Additionally, or alternatively, second end dam assembly 250 comprises a first bridge dam wall 256 disposed on an upper surface of forming body 210 and extending in a thickness direction (e.g., the Y-direction). First bridge dam wall 256 extends between and joins first forming dam wall 252 and second forming dam wall 254.

In some embodiments, second end dam assembly 250 comprises a third forming dam wall 258 extending in the draw direction along a second end 228 of first forming surface 212 opposite first end 224 and/or a fourth forming dam wall 260 extending in the draw direction along a second end 230 of second forming surface 214 opposite first end 226. Additionally, or alternatively, second end dam assembly 250 comprises a second bridge dam wall 262 disposed on the upper surface of forming body 210 and extending in the thickness direction. Second bridge dam wall 262 extends between and joins third forming dam wall 258 and fourth forming dam wall 260.

In some embodiments, first forming dam wall 252 and first forming dam wall 152 are portions of a substantially continuous forming dam wall extending along the first end of first forming surface 212 and first forming surface 112 as shown in FIG. 13. Additionally, or alternatively, second forming dam wall 254 and second forming dam wall 154 are portions of a substantially continuous forming dam wall extending along the first end of second forming surface 214 and second forming surface 114. Additionally, or alternatively, third forming dam wall 258 and third forming dam wall 158 are portions of a substantially continuous forming dam wall extending along the second end of first forming surface 212 and first forming surface 112. Additionally, or alternatively, fourth forming dam wall 260 and fourth forming dam wall 160 are portions of a substantially continuous forming dam wall extending along the second end of second forming surface 214 and second forming surface 114.

In some embodiments, second forming body 210 is disposed on first bridge dam wall 156 and/or second bridge dam wall 162 as shown in FIGS. 13-14. For example, second forming body 210 is mounted on first bridge dam wall 156 and/or second bridge dam wall 162 to couple the second forming body and forming body 110 to one another. Thus, first bridge dam wall 156 and/or second bridge dam wall 162 can be disposed in a gap between the upper forming body and the lower forming body and/or serve as a spacer between the upper forming body and the lower forming body.

In some embodiments, first bridge dam wall 156 and/or second bridge dam wall 162 comprise an H-shaped cross-section as shown in FIGS. 13-14. Thus, a lower bridge dam wall positioned within the gap between the lower forming body and the upper forming body comprises the H-shaped cross-section. Forming body 110 can be disposed or received within a lower opening of the H-shaped cross-section. Additionally, or alternatively, second forming body 210 can be disposed or received within an upper opening of the H-shaped cross-section. Thus, a cross member disposed between two end members of the H-shaped cross-section can be disposed between the lower forming body and the upper forming body, while the two end members are disposed along opposing sides of the lower forming body and the upper forming body. Lower bridge dam walls having such H-shaped cross-sections can help to prevent movement between upper and lower forming bodies (e.g., in the Y-direction) to maintain stability of the apparatus.

Forming body 110, end dam assembly 150, second forming body 210, and/or second end dam assembly 250 comprise or are formed from the same or different refractory materials. For example, first bridge dam wall 156 and/or second bridge dam wall 162 comprise or are formed from the refractory material. In some embodiments, one of end dam assembly 150 or second end dam assembly 250 comprises or is formed from the refractory material and the other of the end dam assembly or the second end dam assembly comprises a non-refractory material. The forming dam walls can be formed from the same or a different material than the bridge dam walls. For example, the forming dam walls of the upper end dam assembly comprise or are formed from the refractory material, and the forming dam walls, but not necessarily the bridge dam walls, of the lower end dam assembly comprise or are formed from the non-refractory material. Also for example, the forming dam walls of the upper end dam assembly comprise or are formed from the non-refractory material, and the forming dam walls of the lower end dam assembly comprise or are formed from the refractory material. The apparatus with the forming bodies and at least one of the end dam assemblies comprising a refractory material can exhibit reduced shape distortion during heat-up and/or operation compared to an apparatus with an end dam assembly formed from a non-refractory material as described herein. The reduction in shape distortion of apparatus 200 can be even more pronounced than the reduction in shape distortion of apparatus 100. For example, because the upper forming body and the lower forming body are coupled to one another, the forming dam walls can be constrained on their upper and lower ends. Such constraint can prevent the upper and/or lower ends of the forming dam walls from moving relative to the forming bodies during heat-up and or operation of the apparatus. Thus, differential expansion between the forming bodies and the forming dam walls can cause warping of the forming dam walls.

In various embodiments, second end dam assembly 250, or portions thereof, can be separate from or integral with forming body 210 as described herein with reference to end dam assembly 150. Additionally, or alternatively, second end dam assembly 250, or portions thereof, can be coupled to forming body 210 as described herein with reference to end dam assembly 150 (e.g., with a joint). Additionally, or alternatively, second end dam assembly 250 can comprise one or more dam wall segments as described herein with reference to end dam assembly 150. Additionally, or alternatively, first end dam assembly 150, or portions thereof, can be separate from or integral with forming body 210. For example, first bridge dam wall 156 and/or second bridge dam wall 162 can be separate from or integral with forming body 210. Additionally, or alternatively, forming body 110 can be separate from or integral with second forming body 210. In some embodiments, the apparatus comprises a unitary or monolithic body in which the upper and lower forming bodies and the first and second end dam assemblies are integral with one another.

In some embodiments, an apparatus for forming a glass ribbon comprises a forming body comprising opposing first and second forming surfaces and an end dam assembly comprising a forming dam wall extending in a draw direction along a first end of the first forming surface, wherein each of the forming body and the end dam assembly comprises a refractory material. Additionally, or alternatively, the end dam assembly further comprises a second forming dam wall extending in the draw direction along a first end of the second forming surface. Additionally, or alternatively, the apparatus further comprises a bridge dam wall disposed on an upper surface of the forming body and extending between and joining the first forming dam wall and the second forming dam wall. Additionally, or alternatively, the bridge dam wall is separate from and in contact with at least one of the first forming dam wall or the second forming dam wall. Additionally, or alternatively, the bridge dam wall is integral with at least one of the first forming dam wall or the second forming dam wall. Additionally, or alternatively, the first and second forming surfaces of the forming body converge at a draw line, and the first forming dam wall and the second forming dam wall converge adjacent the draw line. Additionally, or alternatively, the forming dam wall is disposed within a channel in the forming body. Additionally, or alternatively, the forming dam wall is coupled to the channel in the forming body with a joint. Additionally, or alternatively, the joint is selected from the group consisting of a dovetail joint, an L slot joint, a T slot joint, or a combination thereof. Additionally, or alternatively, at least a portion of the end dam assembly is separate from and in contact with the forming body. Additionally, or alternatively, at least a portion of the end dam assembly is integral with the forming body. Additionally, or alternatively, each of the forming body and the end dam assembly comprises the same refractory material. Additionally, or alternatively, the refractory material is selected from the group consisting of zirconia, alumina, silicon carbide, and combinations thereof. Additionally, or alternatively, the forming body comprises an upper portion in which the first and second forming surfaces are substantially parallel to one another and a lower portion in which the first and second forming surfaces are inclined relative to one another to define a wedge shape of the forming body. Additionally, or alternatively, the end dam assembly further comprises a third forming dam wall extending in the draw direction along a second end of the first forming surface opposite the first end of the first forming surface and a fourth forming dam wall extending in the draw direction along a second end of the second forming surface opposite the first end of the second forming surface. Additionally, or alternatively, the apparatus further comprises a second bridge dam wall disposed on an upper surface of the forming body and extending between and joining the third forming dam wall and the fourth forming dam wall. Additionally, or alternatively, the apparatus further comprises an upper forming body disposed above the forming body and comprising opposing first and second forming surfaces, and an upper end dam assembly comprising a forming dam wall extending in the draw direction along a first end of the first forming surface of the upper forming body, wherein each of the upper forming body and the upper end dam assembly comprises a refractory material. Additionally, or alternatively, the upper end dam assembly further comprises a second forming dam wall extending in the draw direction along a first end of the second forming surface of the upper forming body. Additionally, or alternatively, the apparatus further comprises a bridge dam wall disposed on an upper surface of the upper forming body and extending between and joining the forming dam wall of the upper end dam assembly and the second forming dam wall of the upper end dam assembly. Additionally, or alternatively, a lower bridge dam wall is positioned within a gap between the forming body and the upper forming body. Additionally, or alternatively, the lower bridge dam wall comprises an H-shaped cross section, the forming body is received within a lower opening of the H-shaped cross section, and the upper forming body is received within an upper opening of the H-shaped cross section. Additionally, or alternatively, the upper end dam assembly is in communication with the end dam assembly to cooperatively define a continuous forming dam wall extending in the draw direction along the first end of each of the first forming surface of the upper forming body and the first forming surface of the forming body.

In some embodiments, an apparatus for forming a glass ribbon comprises a lower forming body comprising opposing first and second forming surfaces, an upper forming body disposed above the lower forming body and comprising opposing first and second forming surfaces, and a lower bridge dam wall disposed in a gap between the lower forming body and the upper forming body, wherein each of the lower forming body, the upper forming body, and the lower bridge dam wall comprises a refractory material. Additionally, or alternatively, the apparatus comprises a lower end dam assembly comprising a forming dam wall extending in a draw direction along a first end of the first forming surface of the lower forming body, and an upper end dam assembly comprising a forming dam wall extending in the draw direction along a first end of the first forming surface of the upper forming body, wherein at least one of the lower end dam assembly or the upper end dam assembly comprises a refractory material. Additionally, or alternatively, one of the lower end dam assembly or the upper end dam assembly comprises the refractory material, and the other of the lower end dam assembly or the upper end dam assembly comprises a non-refractory material. Additionally, or alternatively, the non-refractory material comprises a metallic material. Additionally, or alternatively, the metallic material is selected from the group consisting of platinum, rhodium, titanium, alloys thereof, and combinations thereof. Additionally, or alternatively, each of the lower end dam assembly and the upper end dam assembly comprises the refractory material. Additionally, or alternatively, the lower bridge dam wall comprises an H-shaped cross section, the lower forming body is disposed within a lower opening of the H-shaped cross section, and the upper forming body is disposed within an upper opening of the H-shaped cross section. Additionally, or alternatively, each of the lower forming body, the upper forming body, and the lower bridge dam wall comprises the same refractory material. Additionally, or alternatively, the refractory material is selected from the group consisting of zirconia, alumina, silicon carbide, and combinations thereof.

In some embodiments, an apparatus for forming a glass ribbon comprises a forming body comprising opposing first and second forming surfaces, and an end dam assembly comprising a first forming dam wall extending in a draw direction along a first end of the first forming surface, a second forming dam wall extending in the draw direction along a first end of the second forming surface, a first bridge dam wall disposed on an upper surface of the forming body and extending between and joining the first forming dam wall and the second forming dam wall, a third forming dam wall extending in the draw direction along a second end of the first forming surface, a fourth forming dam wall extending in the draw direction along a second end of the second forming surface, a second bridge dam wall disposed on the upper surface of the forming body and extending between and joining the third forming dam wall and the fourth forming dam wall, wherein each of the forming body and the end dam assembly comprises a refractory material. Additionally, or alternatively, the apparatus further comprises an upper forming body coupled to the first bridge dam wall and the second bridge dam wall of the end dam assembly and comprising opposing first and second forming surfaces, and an upper end dam assembly comprising a first forming dam wall extending in the draw direction along a first end of the first forming surface of the upper forming body, a second forming dam wall extending in the draw direction along a first end of the second forming surface of the upper forming body, a third forming dam wall extending in the draw direction along a second end of the first forming surface of the upper forming body opposite the first end, and a fourth forming dam wall extending in the draw direction along a second end of the second forming surface of the upper forming body opposite the first end, wherein each of the upper forming body and the upper end dam assembly comprises a refractory material.

In some embodiments, a method for forming a glass ribbon comprises flowing a molten glass in a draw direction along a forming surface of a wedge-shaped forming body, the molten glass flowing within a trench defined by forming dam walls extending in the draw direction along opposing first and second ends of the forming surface, wherein each of the forming body and the forming dam walls comprises a refractory material.

It will be apparent to those skilled in the art that various modifications and variations can be made without departing from the spirit or scope of the claimed subject matter. Accordingly, the claimed subject matter is not to be restricted except in light of the attached claims and their equivalents.

1. An apparatus for forming a glass ribbon, the apparatus comprising:
a forming body comprising opposing first and second forming surfaces; and
an end dam assembly comprising a forming dam wall extending in a draw direction along a first end of the first forming surface, a second forming dam wall extending in the draw direction along a first end of the second forming surface, and a bridge dam wall disposed on an upper surface of the forming body and extending between and joining the first forming dam wall and the second forming dam wall;
wherein each of the forming body and the end dam assembly comprises a refractory material.

2-3. (canceled)

4. The apparatus of claim 1, wherein the bridge dam wall is separate from and in contact with at least one of the first forming dam wall or the second forming dam wall.

5. The apparatus of claim 1, wherein the bridge dam wall is integral with at least one of the first forming dam wall or the second forming dam wall.

6. The apparatus of claim 1, wherein the forming dam wall is disposed within a channel in the forming body.

7. The apparatus of claim 6, wherein the forming dam wall is coupled to the channel in the forming body with a joint selected from the group consisting of a dovetail joint, an L-slot joint, a T-slot joint, or a combination thereof.

8. The apparatus of claim 1, wherein at least a portion of the end dam assembly is separate from and in contact with the forming body.

9. The apparatus of claim 1, wherein at least a portion of the end dam assembly is integral with the forming body.

10. (canceled)

11. The apparatus of claim 1, the forming body comprising an upper portion in which the first and second forming surfaces are substantially parallel to one another and a lower portion in which the first and second forming surfaces are inclined relative to one another to define a wedge-shape of the forming body.

12. The apparatus of claim 1, the end dam assembly further comprising:
a third forming dam wall extending in the draw direction along a second end of the first forming surface opposite the first end of the first forming surface;
a fourth forming dam wall extending in the draw direction along a second end of the second forming surface opposite the first end of the second forming surface; and
a second bridge dam wall disposed on an upper surface of the forming body and extending between and joining the third forming dam wall and the fourth forming dam wall.

13. The apparatus of any of claims 1 to 12 claim 1, further comprising:
an upper forming body disposed above the forming body and comprising opposing first and second forming surfaces; and
an upper end dam assembly comprising a forming dam wall extending in the draw direction along a first end of the first forming surface of the upper forming body;
wherein each of the upper forming body and the upper end dam assembly comprises a refractory material.

14. The apparatus of claim 13, the upper end dam assembly further comprising:
a second forming dam wall extending in the draw direction along a first end of the second forming surface of the upper forming body; and
a bridge dam wall disposed on an upper surface of the upper forming body and extending between and joining the forming dam wall of the upper end dam assembly and the second forming dam wall of the upper end dam assembly.

15. The apparatus of claim 13, wherein a lower bridge dam wall is positioned within a gap between the forming body and the upper forming body.

16. The apparatus of claim 15, wherein:
the lower bridge dam wall comprises an H-shaped cross-section;
the forming body is received within a lower opening of the H-shaped cross-section; and
the upper forming body is received within an upper opening of the H-shaped cross-section.

17. The apparatus of claim 13, wherein the upper end dam assembly is in communication with the end dam assembly to cooperatively define a continuous forming dam wall extending in the draw direction along the first end of each of the first forming surface of the upper forming body and the first forming surface of the forming body.

18. An apparatus for forming a glass ribbon, the apparatus comprising:
a lower forming body comprising opposing first and second forming surfaces;
an upper forming body disposed above the lower forming body and comprising opposing first and second forming surfaces; and
a lower bridge dam wall disposed in a gap between the lower forming body and the upper forming body;
wherein each of the lower forming body, the upper forming body, and the lower bridge dam wall comprises a refractory material.

19. The apparatus of claim 18, comprising:
a lower end dam assembly comprising a forming dam wall extending in a draw direction along a first end of the first forming surface of the lower forming body; and
an upper end dam assembly comprising a forming dam wall extending in the draw direction along a first end of the first forming surface of the upper forming body;
wherein at least one of the lower end dam assembly or the upper end dam assembly comprises a refractory material.

20. The apparatus of claim 19, wherein one of the lower end dam assembly or the upper end dam assembly comprises the refractory material, and the other of the lower end dam assembly or the upper end dam assembly comprises a non-refractory material.

21. The apparatus of claim 20, wherein the non-refractory material comprises a metallic material selected from the group consisting of platinum, rhodium, titanium, alloys thereof, and combinations thereof.

22. The apparatus of claim 19, wherein each of the lower end dam assembly and the upper end dam assembly comprises the refractory material.

23. The apparatus of claim 18, wherein:
the lower bridge dam wall comprises an H-shaped cross-section;
the lower forming body is disposed within a lower opening of the H-shaped cross-section; and
the upper forming body is disposed within an upper opening of the H-shaped cross-section.

24. (canceled)
